(19) United States
(12) Patent Application Publication
(10) Pub. No.: US 2021/0157303 A1
(43) Pub. Date: May 27, 2021

(54) SMART FACTORY CONTROL SYSTEM USING SMART PLUG FOR PLANT

(71) Applicant: OS LAB Co., Ltd., Changwon-si (KR)

(72) Inventors: Hee Chan Doh, Changwon-si (KR); In Seong LEE, Changwon-si (KR); Jae Mun Park, Changwon-si (KR)

(73) Assignee: OS LAB Co., Ltd., Changwon-si (KR)

(21) Appl. No.: 16/935,221

(22) Filed: Jul. 22, 2020

(30) Foreign Application Priority Data
Nov. 22, 2019 (KR) 10-2019-0151034

(51) Int. Cl. G05B 19/418; G06F 1/3209; G06F 1/3287

(52) U.S. Cl. CPC G05B 19/41855; G06F 1/3209; G06F 1/3287; G05B 19/4183; G05B 19/4188

(57) ABSTRACT

A smart factory control system using a smart plug for a plant, includes: multiple smart plugs each configured to electrically connect, to a socket, each of multiple load devices disposed in at least one plant within a specific manufacturing environment; a management server configured to receive the information from the multiple smart plugs, store the received information in an internal separate storage space, generate control information, and transmit the control information to the smart plug; and at least one gateway positioned for each at least one plant and configured to relay information transmitted from the multiple smart plugs within a specific plant to the management server and information transmitted from the management server to the multiple smart plugs within the specific plant.

### BACKGROUND

### 1. Technical Field

The present disclosure relates to a system capable of controlling a manufacturing environment within a smart factory using a smart plug for a plant.

The present disclosure has been derived as the research results of a development project for a smart plug and control system based on a radio complex for a smart factory carried out as Information Communication Broadcasting Research and Development Business supported by Ministry of Science and ICT and Institute for Information and Communications Technology Promotion
Project Business Name: Information Communication Broadcasting Research and Development business
Research Project Name: Development of a smart plug and control system based on a radio complex for a smart factory
Unique Project Number: 2018-0-01848

### 2. Related Art

A smart factory corresponds to a working environment platform to which a technology for constructing a communication network for the collection of related information and a movement of the information in the entire manufacturing process, monitoring a progress situation for all manufacturing sites, detecting a problem, control the problem in real time, and also preventing the occurrence of a problem through the real-time analysis of the manufacturing environment has been applied.

Recently, a technology related to control of the electrical working environment for manufacturing devices disposed in a plant within a smart factory and the prevention of the occurrence of various problems related to electricity is directly related to the occurrence of various safety accidents related to a fire, a gas leak, an electrical short or device damage within a manufacturing environment. Accordingly, it is continuously necessary to develop and advance a technology related to control of an electrical working environment for various manufacturing devices disposed in multiple plants and the prevention of the occurrence of various problems related to electricity.

A prior art document for a conventional technology provided to manage an electrical working environment for devices using various types of electric power as power supplies includes Korean Patent No. 10-1183388 entitled “Power Monitoring System and Plug Module” (hereinafter referred to as a “conventional technology”).

However, the existing electrical environment control system for manufacturing devices within a smart factory, including the conventional technology, has problems in that it does not effectively integrate and manage the real-time analysis results of various electrical environments within a smart factory, does not enable a manager to easily access the corresponding results and to control the corresponding results in real time, and does not effectively control various safety accidents related to a worker or a fire, a gas leak, an electrical short or damage to a manufacturing device in a manufacturing environment by multilaterally detecting various factors, that is, a cause of the occurrence of various problems related to electricity.

### SUMMARY

Various embodiments are directed to the provision of a technology, in which information on an electrical working environment for various manufacturing devices disposed in multiple plants that provides a manufacturing environment within a smart factory can be effectively integrated and managed in the entire smart factory, a manager can easily access various types of integrated and managed information and easily control an electrical working environment for manufacturing devices based on the corresponding information, and the occurrence of safety accidents can be effectively prevented by multilaterally analyzing various safety accident occurrence factors related to a fire, a gas leak, an electrical short or damage to a manufacturing device in an electrical working environment.

Also, various embodiments are directed to the provision of a technology capable of solving a communication failure problem, which may occur in a communication process of information on an electrical working environment for various manufacturing devices disposed in multiple plants that provide a manufacturing environment within a smart factory, self-diagnosing the state of a sensing device that collects the corresponding information, and calculating, analyzing and using a pattern of consumption power and an environment change pattern based on the corresponding information.

In an embodiment, a smart factory control system using a smart plug for a plant may include multiple smart plugs each configured to electrically connect, to a socket, each of multiple load devices disposed in at least one plant within a specific manufacturing environment and to generate detection information related to an electricity quantity and the occurrence of overload for the multiple load devices each electrically connected to the socket and supplied with a power supply and detection information related to an environment within the plant, a management server configured to receive the information from the multiple smart plugs, store the received information in an internal separate storage space, generate control information for controlling a power supply state of at least one of a power supply provided through the socket of the smart plug and a power supply applied to the multiple load devices based on the received information, and transmit the control information to the smart plug, and at least one gateway positioned for each at least one plant and configured to relay information transmitted from the multiple smart plugs within a specific plant to the management server and information transmitted from the management server to the multiple smart plugs within the specific plant. The multiple smart plugs construct a mesh type communication network through a connection between adjacent smart plugs.

The smart plug may include a power input unit electrically connected to the socket and supplied with the power supply, a power output unit connected to the at least one load device positioned within the plant and configured to apply the power supply to the connected at least one load device, a power detection unit configured to generate power information on the power supply provided through the power input unit and the power supply applied to the at least one load device connected to the power output unit, an environment detection unit configured to generate detection information on an environment change within the plant, an information storage configured to store the information generated by the power detection unit and the environment detection unit, a communication unit configured to transmit, to the management server, the information generated by the power detection unit and the environment detection unit by relaying the information to the gateway and to receive control information from the management server by relaying the control information to the gateway, and a power controller configured to control a power supply state of at least one of the power supply provided through the power input unit or the power supply provided through the power output unit based on the control information received through the communication unit.

Furthermore, the power detection unit may include an individual power detector configured to generate individual electricity quantity information by calculating an individual electricity quantity of a power supply applied to each of the one or more load devices connected to the power output unit and an overload detector configured to determine whether a current value of the power supply provided through the power input unit exceeds a preset overload setting value and to generate overload occurrence information when the current value exceeds the preset overload setting value.

Furthermore, the environment detection unit may include a temperature detection part configured to generate temperature information by detecting a temperature within the plant, a humidity detection part configured to generate humidity information by detecting humidity within the plant, a harmful gas detection part configured to generate harmful gas information by detecting whether a harmful gas has occurred and a concentration of the harmful gas within the plant, a smoke detection part configured to generate smoke occurrence information by detecting whether smoke has occurred within the plant, a vibration detection part configured to generate vibration information by detecting vibration within the plant, and an operating state diagnosis part configured to generate operating state information by diagnosing whether the temperature detection part, the humidity detection part, the harmful gas detection part, the smoke detection part and the vibration detection part operate and an operating state for accuracy of detection results.

Furthermore, the management server may include a server communication unit configured to perform transmission and reception of information by interconnecting the communication unit and the gateway, a server communication unit configured to store the information received through the server communication unit, a first control information generator configured to determine whether an individual electricity quantity belongs to a preset proper power load range based on individual electricity quantity information received through the server communication unit, generate power load control information when the individual electricity quantity indicated by the received individual electricity quantity information does not belong to the preset proper power load range, and transmit the power load control information to the communication unit by relaying the power load control information to the gateway through the server communication unit, a second control information generator configured to generate overload-blocking control information based on overload occurrence information when receiving the overload occurrence information through the server communication unit and to transmit the overload-blocking control information to the communication unit by relaying the overload-blocking control information to the gateway through the server communication unit, and a third control information generator configured to determine a condition corresponding to received information, among whether a preset proper temperature value is exceeded, whether a preset proper humidity value is exceeded, whether a harmful gas has occurred or whether a concentration of the harmful gas exceeds a preset proper value, whether smoke has occurred, and whether a preset proper vibration value is exceeded, based on the received information when at least one of temperature information, humidity information, harmful gas information, smoke occurrence information and vibration information is received through the server communication unit, generate power-blocking control information when at least one of the temperature information, the humidity information or the vibration information exceeds the proper value, when the harmful gas occurs, when smoke occurs or when a concentration of the harmful gas exceeds the proper value, and transmit the power-blocking control information to the communication unit by relaying the power-blocking control information to the gateway through the server communication unit.

The management server may further include a consumption power pattern analysis unit configured to generate consumption power pattern information used to determine a risk factor based on a power use situation classification and a consumption power pattern by analyzing a consumption power pattern for each smart plug based on individual electricity quantity information received through the server communication unit, and a detection information pattern analysis unit configured to generate detection value pattern information used to determine a risk factor based on a detection value pattern by analyzing the detection value pattern of detection information for each smart plug based on at least one of the temperature information and the humidity information received through the server communication unit.

### BRIEF DESCRIPTION OF THE DRAWINGS

FIG. 1 shows a configuration schematically illustrating a smart factory control system using a smart plug for a plant according to an embodiment of the present disclosure.

FIG. 2 is a block diagram showing a detailed configuration of the smart factory control system using a smart plug for a plant according to an embodiment of the present disclosure.

### DETAILED DESCRIPTION

Hereinafter, some embodiments are described in detail with reference to the accompanying drawings, but an already known technical part will be omitted or described in brief for the simplicity of description.

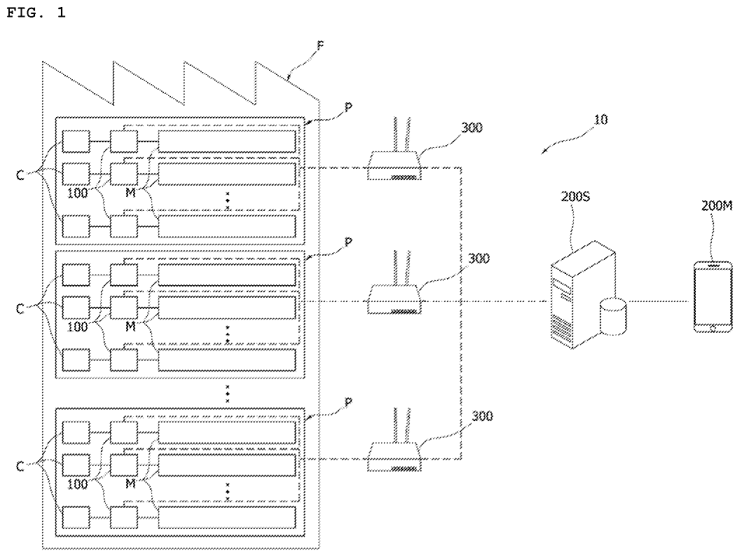

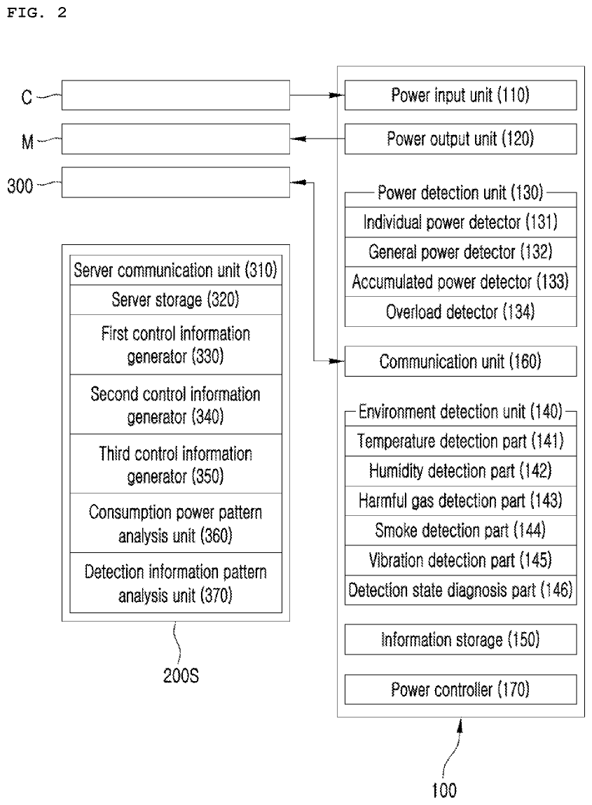

Referring to FIGS. 1 and 2, a smart factory (F) control system 10 using a smart plug 100 for a plant according to an embodiment of the present disclosure includes the smart plug 100, a management server 200S, a management terminal 200M, and a gateway 300.

The smart plug 100 electrically connects sockets C and multiple load devices M installed on at least one plant P that provides a specific manufacturing environment within a smart factory F to which the system 10 according to an embodiment of the present disclosure has been applied.

Furthermore, the smart plug 100 generates information on individual electricity quantity, accumulated electricity quantity and the occurrence of overload for the multiple load devices M electrically connected to the sockets C and provided with a power supply and environment information related to a temperature, humidity and harmful gas within the plant, and transmits the generated information to the external management server 200S or management terminal 200M through a gateway 300.

Furthermore, the smart plug 100 receives various control signals generated based on detection result information received from the external management server 200S or management terminal 200M, and performs various control operations based on the various control signals.

To this end, the smart plug 100 includes a power input unit 110, a power output unit 120, a power detection unit 130, an environment detection unit 140, an information storage 150, a communication unit 160, and a power controller 170.

First, as shown in FIG. 1, the smart plug 100 for a plant according to an embodiment of the present disclosure is connected between the socket C and the load device M, corresponding to a manufacturing device positioned in the plant P that is divided within the smart factory and that forms a manufacturing task area in order to receive a power supply, in a relay form. The smart plug 100 performs power control based on electrical information and environmental information and communication with the external management server 200S or management terminal 200M.

The power input unit 110 is a plug terminal part electrically connected to the socket C and provided with the power supply, and corresponds to a start portion through which the power supply is input to the smart plug 100 according to an embodiment of the present disclosure.

Accordingly, the power supply provided through the power input unit 110 is moved to the power output unit 120, and is used as an operating power supply for various functional elements for detecting, generating, collecting, storing, and transmitting and receiving electrical information and environmental information within the smart plug 100 according to an embodiment of the present disclosure.

The power output unit 120 is a plug terminal part to which the at least one load device M positioned within the plant P is connected, for applying the power supply to the connected at least one load device M.

In this case, the power supply provided to the at least one load device M through the power output unit 120 is used as an operating power supply for the load device M corresponding to various manufacturing devices.

Furthermore, the plurality of power output units 120 may be connected so that the at least one load device M can be electrically connected to the power output units 120.

The power detection unit 130 generates power information on the power supply provided through the power input unit 110 and the power supply applied to the at least one load device connected to the power output unit 120.

To this end, the power detection unit 130 includes an individual power detector 131, a general power detector 132, an accumulation power detector 133 and an overload detector 134.

First, the individual power detector 131 generates individual power quantity information by calculating individual electricity quantity of a power supply provided to each of the one or more at least one load devices M connected to the power output unit 120.

In this case, the individual power detector 131 may be provided as an electricity quantity measurement sensor itself. However, in some embodiments, the individual power detector 131 may be provided in a form including a separate current sensor and voltage sensor and a power calculator for calculating a power value based on a current value and voltage value that are measured together.

Specifically, if multiple load devices M are connected to multiple power output units 120, the individual power detector 131 detects and calculates an individual electricity quantity applied to each of the multiple load devices M and generates corresponding information (or data).

If the number of load devices M connected to the power output unit 120 is plural, the general power detector 132 generates general electricity quantity information by calculating a general electricity quantity by summing pieces of individual electricity quantity information of the multiple load devices M each generated by the individual power detector 131, respectively.

In this case, the general power detector 132 may generate the general electricity quantity information by summing all of the pieces of individual electricity quantity information each generated through the individual power detector 131.

Furthermore, according to embodiments, the general power detector 132 may be provided in a form, including an electricity quantity measurement sensor itself or a separate current sensor and voltage sensor and a power calculator for calculating a power value based on a current value and voltage value that are measured together, may detect and calculate an individual electricity quantity of each of multiple load devices M connected to multiple power output units 120, and may generate information (or data) by summing all of the electricity quantities of the multiple load devices M.

The accumulation power detector 133 generates accumulated electricity quantity information by cumulatively calculating an individual electricity quantity applied to each of the one or more at least one load devices M connected to the power output unit 120 through the individual power detector 131.

The overload detector 134 determines whether a current value of a power supply provided through the power input unit 110 exceeds a preset overload setting value, and generates overload occurrence information when the current value exceeds the preset overload setting value.

In this case, the overload detector 134 includes an overload sensor, determines whether overload has occurred in a power supply provided from the socket C before the power supply is applied to the load device M connected to the power output unit 120, and generates information (or data) to be provided to the management server 200S or the management terminal 200M so that a manager can recognize the occurrence of the overload.

Furthermore, the function of the overload detector 134 is not limited to the function for determining whether a current value of a power supply provided through the power input unit 110 exceeds a preset overload setting value. In some embodiment, the overload detector 134 may determine whether a current value of a power supply provided from the power output unit 120 to the load device M exceeds a preset overload setting value, and may generate overload occurrence information when the current value exceeds preset overload setting value.

Furthermore, the overload detector 134 may be additionally provided within a separate temperature sensor or associated with a temperature detection part 141 within the environment detection unit 140, may detect a level of heat generated from the smart plug 100 itself due to overload of a power supply, and may generate overload occurrence information when the level of heat exceeds a preset overload setting temperature value.

The environment detection unit 140 corresponds to a multi-sensor module unit for detecting an environment change related to a temperature, humidity, harmful gas, smoke, or vibration within the plant P, and generates corresponding detection information based on a detected data value.

Specifically, to this end, the environment detection unit 140 includes a temperature detection part 141, a humidity detection part 142, a harmful gas detection part 143, a smoke detection part 144, and a vibration detection part 145.

The temperature detection part 141 detects a temperature within the plant P through a temperature sensor, and generates temperature information based on a detected information value.

Specifically, the temperature detection part 141 detects a temperature within a preset temperature sensing range around the location where the smart plug 100 according to an embodiment of the present disclosure has been installed within the plant P. In some embodiments, the temperature detection part 141 may use, as a basis, a temperature generated from the smart plug 100 itself according to an embodiment of the present disclosure.

Furthermore, the corresponding temperature information is transmitted to the external management server 200S or management terminal 200M in a preset given notification cycle through the communication unit 160.

The temperature detection part 141 gradually decreases the notification cycle for the external management server 200S or management terminal 200M through the communication unit 160 as a temperature level appearing in generated temperature information is increased.

The humidity detection part 142 detects humidity within the plant P through a humidity sensor, and generates humidity information based on a detected information value.

Specifically, the humidity detection part 142 detects humidity within a preset humidity sensing range around the location where the smart plug 100 according to an embodiment of the present disclosure has been installed within the plant P. In some embodiments, the humidity detection part 142 may use, as a basis, humidity of the smart plug 100 itself according to an embodiment of the present disclosure.

Furthermore, the corresponding humidity information is transmitted to the external management server 200S or management terminal 200M in a preset given notification cycle through the communication unit 160.

The humidity detection part 142 gradually decreases the notification cycle for the external management server 200S or management terminal 200M through the communication unit 160 as a humidity level appearing in generated humidity information is increased.

The harmful gas detection part 143 generates harmful gas information by detecting whether a harmful gas has occurred and a concentration of the harmful gas within the plant P through at least one gas sensor for detecting various harmful gases occurring due to a fire.

Specifically, the harmful gas detection part 143 includes multiple gas sensors for detecting whether a harmful gas, such as nitrogen oxide, hydrocarbon, fluorocompound or carbon monoxide, is present and a concentration of the harmful gas.

Furthermore, the harmful gas detection part 143 detects a harmful gas within a preset harmful gas sensing range around the location where the smart plug 100 according to an embodiment of the present disclosure has been installed within the plant P.

The harmful gas information generated by the harmful gas detection part 143 as described above indicates fact information on whether a harmful gas has occurred and concentration information on a degree of a concentration of the harmful gas. The corresponding harmful gas information is transmitted to the external management server 200S or the management server 200M in a preset given notification cycle through the communication unit 160.

The harmful gas detection part 143 gradually decreases the notification cycle for the external management server 200S or management terminal 200M through the communication unit 160 as a harmful gas concentration appearing in the generated harmful gas information is increased.

The smoke detection part 144 generates smoke occurrence information by detecting whether smoke has occurred within the plant P through a smoke sensor for detecting smoke occurring due to a fire.

Specifically, the smoke detection part 144 detects smoke within a preset smoke sensing range around the location where the smart plug 100 according to an embodiment of the present disclosure has been installed within the plant P.

Furthermore, the corresponding smoke occurrence information is transmitted to the external management server 200S or management terminal 200M in a preset given notification cycle through the communication unit 160.

The vibration detection part 145 detects vibration within the plant P through a vibration sensor, and generates vibration information based on a detected information value.

Specifically, the vibration detection part 145 detects a level of vibration within a preset vibration sensing range around the location where the smart plug 100 according to an embodiment of the present disclosure has been installed within the plant P. In some embodiments, the vibration detection part 145 may use, as a basis, vibration of the smart plug 100 itself according to an embodiment of the present disclosure.

Furthermore, the corresponding vibration information is transmitted to the external management server 200S or management terminal 200M in a preset given notification cycle through the communication unit 160.

The vibration detection part 145 gradually decreases the notification cycle for the external management server 200S or management terminal 200M through the communication unit 160 as a vibration level appearing in generated vibration information is increased.

The operating state diagnosis part 146 generates operating state information by diagnosing whether the temperature detection part 141, the humidity detection part 142, the harmful gas detection part 142, the smoke detection part 143 and the vibration detection part 144 operate and diagnosing the operating state for the accuracy of detection results.

Specifically, the operating state diagnosis part 146 is an element for determining whether the temperature detection part 141, the humidity detection part 142, the harmful gas detection part 142, the smoke detection part 143 and the vibration detection part 144 operate normally in real time, whether a failure has occurred in the detection parts, and digitizing the results of the determination. The operating state diagnosis part 146 performs a method of transmitting a diagnosis signal and checking a response thereto and a method of analyzing the accuracy of result information of a detection operation performed by each detection part.

The information storage 150 is a storage space having a database form for storing information generated by the power detection unit 130 and the environment detection unit 140.

Accordingly, the information storage 150 stores individual electricity quantity information, general electricity quantity information, accumulated electricity quantity information, overload occurrence information, temperature information, humidity information, harmful gas information, smoke occurrence information, vibration information, etc. in real time for each time.

The communication unit 160 transmits, to the external management server 200S or management terminal 200M, detection information generated by the power detection unit 130 and the environment detection unit 140, and receives various types of control information from the external management server 200S or management terminal 200M as responses thereto.

Specifically, the communication unit 160 may form a short-distance wireless communication network along with the gateway 300 installed for each plant P through Bluetooth, but the present disclosure is not limited thereto. The communication unit 160 may be provided in various forms, such as a short-distance radio communication module such as RF communication (or radio frequency), communication using Bluetooth or near field communication (NFC), or a long-distance wireless communication module using a mobile communication network.

The external management server 200S or management terminal 200M receives individual electricity quantity information, accumulated electricity quantity information, overload occurrence information, temperature information, humidity information, harmful gas information, smoke occurrence information, or vibration information from the communication unit 160 in real time, stores the received information in a separate storage space thereof, generates corresponding control information based on some of the pieces of received information, and transmits the corresponding control information to the communication unit 160.

The power controller 170 controls the type of power supply to the smart plug 100 according to an embodiment of the present disclosure based on various types of control information received from the external management server 200S or management terminal 200M through the communication unit 160 so that the power supply can be efficiently managed and a safety accident attributable to an electrical or environmental factor is immediately prevented in real time.

Specifically, the external management server 200S or management terminal 200M receives individual electricity quantity information from the communication unit 160, determines whether each individual electricity quantity belongs to a preset proper power load range based on the individual electricity quantity information, and generates power load control information when each individual electricity quantity indicated by the received individual electricity quantity information does not belong to the preset proper power load range.

In this case, the generated power load control information includes a control signal for enabling each individual electricity quantity to belong to the preset proper power load range. Accordingly, the individual power load level of each of the one or more at least one load devices M connected to the power output unit 120 can be properly controlled.

To this end, the external management server 200S or management terminal 200M transmits the generated power load control information to the communication unit 160. The power controller 170 adjusts at least one power load level of a power supply provided through the power input unit 110 or a power supply provided through the power output unit 130 within a preset proper power load range based on the power load control information received through the communication unit 160.

Furthermore, the external management server 200S or management terminal 200M receives overload occurrence information from the communication unit 160, and generates overload-blocking control information based on the overload occurrence information.

The generated overload-blocking control information includes a control signal for fundamentally blocking overload of a power supply applied to the smart plug 100 or a power supply provided from the smart plug 100.

Accordingly, an overload problem occurring due to a power supply provided through the power input unit 110 or a power supply provided through the power output unit 130 can be solved.

To this end, the external management server 200S or management terminal 200M transmits the generated overload-blocking control information to the communication unit 160. The power controller 170 blocks the supply of at least one of the power supply provided through the power input unit 110 or the power supply provided through the power output unit 130 based on the overload-blocking control information received through the communication unit 160.

Furthermore, the external management server 200S or management terminal 200M receives at least one of temperature information, humidity information, and vibration information from the communication unit 160, determines whether at least one of a preset proper temperature value, a preset proper humidity value and a preset proper vibration value is exceeded based on the received information, and generates power-blocking control information when at least one of the received temperature information, the humidity information and the vibration information exceeds the proper value.

In this case, the generated power-blocking control information includes a control signal for recognizing that at least one environment value of a temperature, humidity and vibration does not belong to a preset proper range and for blocking power in order to prevent various safety accident problems which may occur due to such an environmental factor.

To this end, the external management server 200S or management terminal 200M transmits the generated power-blocking control information to the communication unit 160. The power controller 170 blocks the supply of at least one of a power supply provided through the power input unit 110 or a power supply provided through the power output unit 130 based on the power-blocking control information received through the communication unit 160.

The external management server 200S or management terminal 200M receives at least one of harmful gas information and smoke occurrence information from the communication unit 160, determines whether a harmful gas or smoke has occurred or a harmful gas concentration exceeds a preset proper value, and generates power-blocking control information when a harmful gas or smoke occurs or the harmful gas concentration exceeds the proper value.

The generated power-blocking control information includes a control signal for recognizing that an environmental factor for the occurrence of at least one safety accident related to a harmful gas and smoke has occurred or a level of harmful gas occurrence does not belong to the preset proper range and for blocking power in order to prevent various safety accident problems which may occur due to such an environmental factor.

To this end, the external management server 200S or management terminal 200M transmits the generated power-blocking control information to the communication unit 160. The power controller 170 blocks the supply of at least one of a power supply provided through the power input unit 110 or a power supply provided through the power output unit 130 based on the power-blocking control information received through the communication unit 160.

Furthermore, a noise remover (not shown) and a surge protector (not shown) may be further included on an internal circuit board that forms the smart plug 100 according to an embodiment of the present disclosure.

In this case, the noise remover (not shown) is electrically connected to the power input unit 110, and functions as a filter for suppressing noise on an input power supply. The surge protector (not shown) is also electrically connected the power input unit 110 or the noise remover (not shown), and functions to discharge a voltage exceeding a preset reference voltage level in addition to the surge of a power supply.

The multiple smart plugs 100 construct a mesh type communication network through a connection between the communication units 160 within the smart plugs 100 for adjacent plants. Although a communication failure occurs in the gateway 300 through the communication unit 160 of one smart plug 100, the communication unit 160 of the other smart plug 100 can perform communication with the gateway 300.

The management server 200S receives information generated by the multiple smart plugs 100, stores the received information in an internal separate storage space thereof, generates control information for controlling the power supply state of at least one of a power supply provided through the socket C of the smart plug 100 or power supplies provided through multiple load devices M based on the received information, and transmits the control information to the smart plug 100.

In this case, the management server 200S may directly receive pieces of corresponding information from the multiple smart plugs 100 over a long-distance wireless communication network, such as a mobile communication network, but receives the pieces of corresponding information through the relay of the gateway 300.

To this end, the management server 200S includes a server communication unit 310, a server storage 320, a first control information generator 330, a second control information generator 340, a third control information generator 350, a consumption power pattern analysis unit 360 and a detection information pattern analysis unit 370.

First, the server communication unit 310 performs the transmission and reception of information by interconnecting the communication unit 160 and the gateway 300.

The server storage 320 is a database for storing information received through the server communication unit 310.

Furthermore, the first control information generator 330 determines whether each individual electricity quantity belongs to a preset proper power load range based on individual electricity quantity information received through the server communication unit 310, generates power load control information when each individual electricity quantity indicated by the received individual electricity quantity information does not belong to the preset proper power load range, and transmits the power load control information to the communication unit 160 through the relay of the gateway 300 using the server communication unit 310.

Furthermore, when overload occurrence information is received through the server communication unit 310, the second control information generator 340 generates overload-blocking control information based on the received overload occurrence information, and transmits the overload-blocking control information to the communication unit 1600 through the relay of the gateway 300 using the server communication unit 310.

Furthermore, when at least one of temperature information, humidity information, harmful gas information, smoke occurrence information and vibration information is received through the server communication unit 310, the third control information generator 350 determines a condition corresponding to received information, among whether a preset proper temperature value is exceeded, whether a preset proper humidity value is exceeded, whether harmful gas has occurred or a harmful gas concentration exceeds a preset proper value, whether smoke has occurred, and whether a preset proper vibration value is exceeded, based on the received information, generates power-blocking control information when at least one of the temperature information, the humidity information or the vibration information exceeds the proper value, when harmful gas occurs, when smoke occurs, or when the harmful gas concentration exceeds the proper value, and transmits the power-blocking control information to the communication unit 160 through the relay of the gateway 300 using the server communication unit 310.

The consumption power pattern analysis unit 360 generates consumption power pattern information used to determine a risk factor based on a power use situation classification and a consumption power pattern by analyzing a consumption power pattern for each smart plug 100 based on individual electricity quantity information received through the server communication unit 310.

The generated consumption power pattern information is used to predict a risk factor and derive a risk handling method based on power pattern analysis for each power usage.

The detection information pattern analysis unit 370 generates detection value pattern information to be used to determine a risk factor based on a detection value pattern by analyzing a detection value pattern of detection information for each smart plug 100 based on at least one of temperature information and humidity information received through the server communication unit 310.

The generated detection value pattern information is used to cumulatively secure information on a detection value pattern of a danger situation. Pattern analysis based on the information is used to predict and handle an environmental dangerous situation.

The gateway 300 is positioned in at least one plant P. As shown in FIG. 1, the gateway 300 relays information transmitted from the multiple smart plugs 100 within a specific plant P to the management server 200S or the management terminal 200M and information transmitted from the management server 200S or the management terminal 200M to the multiple smart plugs 100 within the specific plant P.

Accordingly, at least one gateway 300 is provided in at least one plant P. A specific gateway 300 exchanges information with the multiple smart plugs 100 within a corresponding specific plant P through short-distance wireless communication.

The present disclosure has the following effects.

First, information on an electrical working environment for various manufacturing devices disposed in multiple plants that provide a manufacturing environment within a smart factory can be effectively integrated and managed in the entire smart factory.

Second, a manager can be easily provided with information on an electrical working environment for various manufacturing devices disposed in multiple plants that are integrated and managed in the entire smart factory in real time.

Third, a manager can easily control an electrical working environment for various manufacturing devices disposed in multiple plants in real time based on information on the electrical working environment for the various manufacturing devices disposed in the multiple plants that are integrated and managed in the entire smart factory.

Fourth, a cause of an accident can be accurately and rapidly checked by multilaterally analyzing various safety accident occurrence factors related to a worker or a fire, a gas leak, an electrical short or damage to a manufacturing device in an electrical working environment for various manufacturing devices disposed in multiple plants that provide a manufacturing environment within a smart factory.

Fifth, the occurrence of various safety accidents related to a worker or a fire, a gas leak, an electrical short or damage to a manufacturing device in an electrical working environment for various manufacturing devices disposed in multiple plants that provide a manufacturing environment within a smart factory can be effectively prevented.

Sixth, an obstacle problem in information communication can be immediately handled through the construction of a mesh type wireless communication network between the smart plugs.

Seventh, a failure can be immediately determined and handled by self-diagnosing the operating state and operation performance of each of the detection parts that configure an environment detection unit in real time.

Sixth, a pattern can be calculated and analyzed based on power information and information on an environment change, and a risk factor using the corresponding analysis results can be predicted, confirmed and handled.

The embodiments described in the present disclosure should not be construed as limiting the technical spirit of the present disclosure, but should be construed as describing the technical spirit of the present disclosure. The technical spirit of the present disclosure is not restricted by the embodiments. The range of protection of the present disclosure should be construed based on the following claims, and all of technical spirits within an equivalent range thereof should be construed as being included in the scope of rights of the present disclosure.

What is claimed is:

1. A smart factory control system using a smart plug for a plant, comprising:
multiple smart plugs each configured to electrically connect, to a socket, each of multiple load devices disposed in at least one plant within a specific manufacturing environment and to generate detection information related to an electricity quantity and occurrence of overload for the multiple load devices each electrically connected to the socket and supplied with a power supply and detection information related to an environment within the plant;
a management server configured to receive the information from the multiple smart plugs, store the received information in an internal separate storage space, generate control information for controlling a power supply state of at least one of a power supply provided through the socket of the smart plug and a power supply applied to the multiple load devices based on the received information, and transmit the control information to the smart plug; and
at least one gateway positioned for each at least one plant and configured to relay information transmitted from the multiple smart plugs within a specific plant to the management server and information transmitted from the management server to the multiple smart plugs within the specific plant,
wherein the multiple smart plugs construct a mesh type communication network through a connection between adjacent smart plugs.

2. The smart factory control system of claim 1, wherein the smart plug comprises:
a power input unit electrically connected to the socket and supplied with the power supply;
a power output unit connected to the at least one load device positioned within the plant and configured to apply the power supply to the connected at least one load device;
a power detection unit configured to generate power information on the power supply provided through the power input unit and the power supply applied to the at least one load device connected to the power output unit;
an environment detection unit configured to generate detection information on an environment change within the plant;
an information storage configured to store the information generated by the power detection unit and the environment detection unit;
a communication unit configured to transmit, to the management server, the information generated by the power detection unit and the environment detection unit by relaying the information to the gateway and to receive control information from the management server by relaying the control information to the gateway; and
a power controller configured to control a power supply state of at least one of the power supply provided through the power input unit or the power supply provided through the power output unit based on the control information received through the communication unit.

3. The smart factory control system of claim 2, wherein the power detection unit comprises:
an individual power detector configured to generate individual electricity quantity information by calculating an individual electricity quantity of a power supply applied to each of the one or more load devices connected to the power output unit, and
an overload detector configured to determine whether a current value of the power supply provided through the power input unit exceeds a preset overload setting value and to generate overload occurrence information when the current value exceeds the preset overload setting value.

4. The smart factory control system of claim 3, wherein the environment detection unit comprises:
a temperature detection part configured to generate temperature information by detecting a temperature within the plant;
a humidity detection part configured to generate humidity information by detecting humidity within the plant;
a harmful gas detection part configured to generate harmful gas information by detecting whether a harmful gas has occurred and a concentration of the harmful gas within the plant;
a smoke detection part configured to generate smoke occurrence information by detecting whether smoke has occurred within the plant;
a vibration detection part configured to generate vibration information by detecting vibration within the plant; and
an operating state diagnosis part configured to generate operating state information by diagnosing whether the temperature detection part, the humidity detection part, the harmful gas detection part, the smoke detection part and the vibration detection part operate and an operating state for accuracy of detection results.

5. The smart factory control system of claim 4, wherein the management server comprises:
a server communication unit configured to perform transmission and reception of information by interconnecting the communication unit and the gateway;
a server communication unit configured to store the information received through the server communication unit;
a first control information generator configured to determine whether an individual electricity quantity belongs to a preset proper power load range based on individual electricity quantity information received through the server communication unit, generate power load control information when the individual electricity quantity indicated by the received individual electricity quantity information does not belong to the preset proper power load range, and transmit the power load control information to the communication unit by relaying the power load control information to the gateway through the server communication unit;
a second control information generator configured to generate overload-blocking control information based on overload occurrence information when receiving the overload occurrence information through the server communication unit and to transmit the overload-blocking control information to the communication unit by relaying the overload-blocking control information to the gateway through the server communication unit; and
a third control information generator configured to determine a condition corresponding to received information, among whether a preset proper temperature value is exceeded, whether a preset proper humidity value is exceeded, whether a harmful gas has occurred or whether a concentration of the harmful gas exceeds a preset proper value, whether smoke has occurred, and whether a preset proper vibration value is exceeded, based on the received information when at least one of temperature information, humidity information, harmful gas information, smoke occurrence information and vibration information is received through the server communication unit, generate power-blocking control information when at least one of the temperature information, the humidity information or the vibration information exceeds the proper value, when the harmful gas occurs, when smoke occurs or when a concentration of the harmful gas exceeds the proper value, and transmit the power-blocking control information to the communication unit by relaying the power-blocking control information to the gateway through the server communication unit.

6. The smart factory control system of claim 5, wherein the management server further comprises:
a consumption power pattern analysis unit configured to generate consumption power pattern information used to determine a risk factor based on a power use situation classification and a consumption power pattern by analyzing a consumption power pattern for each smart plug based on individual electricity quantity information received through the server communication unit; and
a detection information pattern analysis unit configured to generate detection value pattern information used to determine a risk factor based on a detection value pattern by analyzing the detection value pattern of detection information for each smart plug based on at least one of the temperature information and the humidity information received through the server communication unit.
